(19) United States
(12) Patent Application Publication
(10) Pub. No.: US 2023/0213128 A1
(43) Pub. Date: Jul. 6, 2023

(54) QUICK CONNECTOR

(71) Applicant: CHIA CHERNE INDUSTRY CO., LTD., Chang Hwa Hsien (TW)

(72) Inventor: Yung-Pin KUO, Chang Hwa Hsien (TW)

(21) Appl. No.: 17/567,298

(22) Filed: Jan. 3, 2022

(51) Int. Cl. F16L 37/23; F16L 29/04; F16L 37/34; F16L 37/38; F16L 37/35; F16L 37/36

(52) U.S. Cl. CPC F16L 37/23; F16L 29/04; F16L 37/34; F16L 37/38; F16L 37/35; F16L 37/36; F16L 2201/10

(57) ABSTRACT

A quick connector includes a male base and a female base, wherein the male base has a first tube body, an annular clamping groove arranged outside the first tube body, a first flow channel axially penetrating through the first tube body, a plug body slidably arranged in the first flow channel, and an elastic member for pushing the plug body to close the first flow channel. The female base includes a second tube body, a second flow channel which axially penetrates through the second tube body and into which the first tube body is inserted, an annular fastener provided in the second flow channel, and a push rod fixed on the second flow channel and oriented towards the plug body.

### FIELD OF THE INVENTION

The invention relates to a pipe connector, particularly relates to a quick connector for reducing fluid leakage of a pipe.

### BACKGROUND OF THE INVENTION

The water cooling system that uses fluid for heat exchange has been widely used in high-performance electronics due to excellent heat dissipation efficiency. A cooling fluid is provided as the heat exchange medium in the water cooling system since it has high thermal conductivity, and the cooling fluid performs heat exchange by following steps, entering a cavity to quickly take away heat, flowing out to an external heat dissipation device to quickly cool down, and then flowing into the cavity again to form a circulating heat dissipation system.

The fluid pipe used in the water cooling system is provided with connectors to be reassembled when cleaning, repairing, and maintenance. The water cooling system provided with connectors is suitable for installation needs in various operating environments. In conventional technique, in order to prevent the cooling fluid from leaking out, reduce environmental hazards, and avoid damage to the machine due to moisture, the cooling fluid must be collected first to reassemble the connectors, which is troublesome and inconvenient.

### SUMMARY OF THE INVENTION

The main purpose of the invention is to provide a quick connector that reduces the leakage of the cooling fluid for convenience during reassembly of the product by eliminating the need for collecting the cooling fluid beforehand.

To achieve the above purpose, the invention provides a quick connector, which comprises a male base and a female base. The male base comprises a first tube body, an annular clamping groove, a first flow channel, a plug body and an elastic member. The annular clamping groove is arranged outside the first tube body; the first flow channel axially penetrates through the first tube body; the plug body is slidably arranged in the first flow channel; and the elastic member pushes the plug body to close the first flow channel.

The female base comprises a second tube body, a second flow channel, an annular fastener and a push rod. The second flow channel axially penetrates through the second tube body and is provided for the first tube body to be inserted therein. The annular fastener is provided in the second flow channel and clamped on the annular clamping groove. The push rod is fixed on the second flow channel and extended towards the plug body, wherein a size of the push rod is matched with a size of the plug body. When the first tube body is inserted into the second flow channel and the annular fastener is fixed to the annular clamping groove, the push rod pushes the elastic member to displace the plug body and communicates the second flow channel with the first flow channel.

Accordingly, when the male base and the female base is disconnected, the plug body of the invention closes the first flow channel and avoids the problem of leakage. When the male base and the female base are connected, the first tube body is inserted in the second flow channel, until the annular fastener is clamped on the annular clamping groove, and the push rod pushes the elastic member to displace the plug body and to communicate the second flow channel with the first flow channel. Thus, the leakage is reduced and is more convenient for use.

### BRIEF DESCRIPTION OF THE DRAWINGS

FIG. 1 is a perspective view of the invention.

FIG. 2 is a cross-section diagram of the invention.

FIG. 3 is another cross-section diagram of the invention.

### DETAILED DESCRIPTION OF THE PREFERRED EMBODIMENTS

The detailed description and technical content of the invention are described as follows:

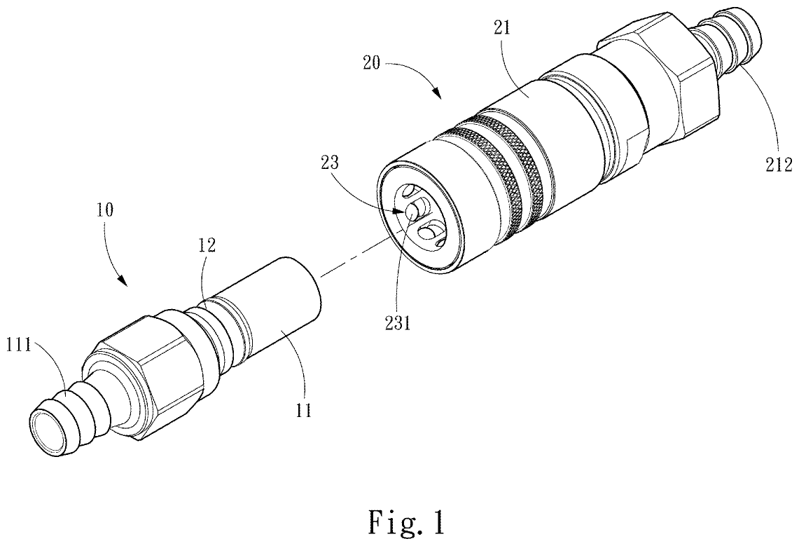

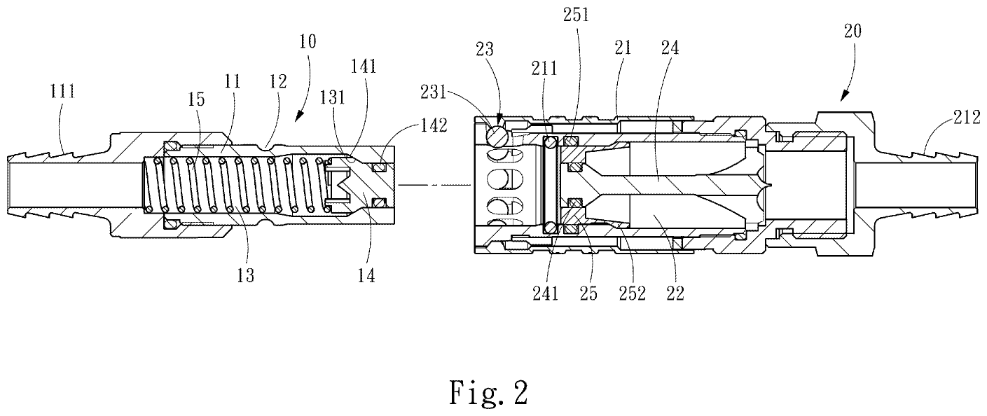

As shown in FIG. 1 and FIG. 2, the invention provides a quick connector that comprises a male base 10 and a female base 20. The male base 10 comprises a first tube body 11, an annular clamping groove 12, a first flow channel 13, a plug body 14 and an elastic member 15. The annular clamping groove 12 is arranged outside the first tube body 11; the first flow channel 13 axially penetrates through the first tube body 11; the plug body 14 is slidably arranged in the first flow channel 13; and the elastic member 15 pushes the plug body 14 to close the first flow channel 13 (as shown in FIG. 2). In one embodiment, the first flow channel 13 comprises a tapered inner surface 131, and the plug body 14 comprises a tapered outer surface 141 corresponding to the tapered inner surface 131. Through matching a shape of the tapered inner surface 131 and a shape of the tapered outer surface 141, a good sealing effect is realized. In one embodiment, the plug body 14 is further provided with a first seal ring 142 contacting the first tube body 11 to increase the sealing effect.

The female base 20 comprises a second tube body 21, a second flow channel 22, an annular fastener 23 and a push rod 24. The second flow channel 22 axially penetrated through the second tube body 21 and provided for inserting in the first tube body 11. The annular fastener 23 is provided in the second flow channel 22 and clamped on the annular clamping groove 12 to provide fixing effect. In one embodiment, the annular fastener 23 further comprises a plurality of roller balls 231 in contact with the second tube body 21, to enhance sliding ability between the second tube body 21 and the first tube body 11.

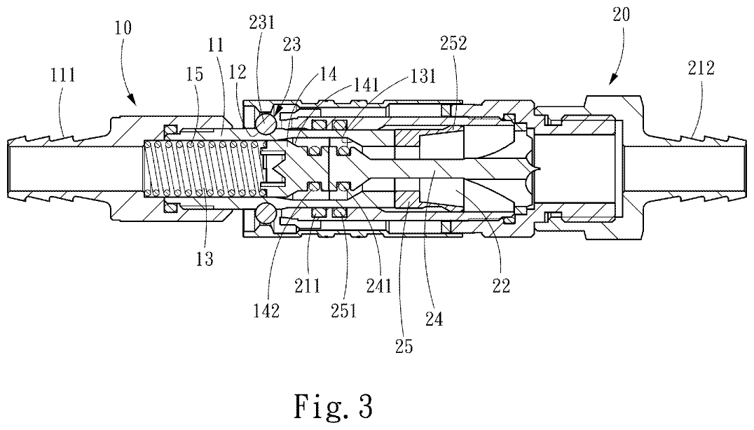

As shown in FIG. 3, the push rod 24 is fixed on the second flow channel 22 and extended towards the plug body 14, wherein a size of the push rod 24 is matched with a size of the plug body 14. When the first tube body 11 is inserted into the second flow channel 22 and the annular fastener 23 is clamped on the annular clamping groove 12, the push rod 24 pushes the elastic member 15 to displace the plug body 14 and to communicate the first flow channel 13 with the second flow channel 22.

To further reduce the leakage of fluid, the second tube body 21 is provided with a second seal ring 211 adjacent to the push rod 24; and the second seal ring 211 contacts the first tube body 11. Before the first tube body 11 is inserted in the second flow channel 22 and the push rod 24 pushes the elastic member 15, the second seal ring 211 contacts the first tube body 11 to produce a sealing effect, which minimize the leakage of the fluid.

In one embodiment, to assemble with other pipes (not shown in figures), one end of the first tube body 11 is provided with a first backstop member 111, and the other end of the first tube body 11 is inserted into the second flow channel 22. Similarly, one end of the second tube body 21 is provided with a second backstop member 212, and the other end of the second tube body 21 is provided with the annular fastener 23. The first backstop member 111 and the second backstop member 212 is connected with other pipes to meet assembly needs.

In order to further reduce the leakage of fluid, the second flow channel 22 is provided with a movable plug 25 between the push rod 24 and the second tube body 21. The movable plug 25 closes the second flow channel 22. When the first tube body 11 is inserted in the second flow channel 22 and the annular fastener 23 is clamped in the annular clamping groove 12, the first tube body 11 pushes the movable plug 25 to communicate the second flow channel 22 with the first flow channel. In one embodiment, the push rod 24 and the second tube body 21 are respectively provided with a third seal ring 241, 251. The two third seal rings 241, 251 contact the upper and lower sides of the movable plug 25 respectively. In one embodiment, in order to automatically reset the movable plug 25, the movable plug 25 comprises a tube 252 tightly attached to the second tube body 21. Once the first tube body 11 and the second flow channel 22 is disconnected, the movable plug 25 is pushed to fit in a position between the push rod 24 and the second tube body 21 through the fluid pressure in the second flow channel 22, to close the second flow channel 22 again.

The improvement of the invention comprises:

1. The plug body closes the first flow channel without the leakage problem; and when the male base and the female base are connected, the first tube body is inserted in the second flow channel, until the annular fastener is clamped on the annular clamping groove, and the push rod pushes the elastic member to displace the plug body and to communicate the second flow channel with the first flow channel. Thus, the leakage is reduced.

2. The plug body provides the tapered outer surface, which effectively blocks the fluid and avoids fluid leakage.

3. The second tube body is provided with the second seal ring adjacent to the push rod. Before the first tube body is inserted in the second flow channel and the push rod pushes the elastic member, the second seal ring contacts the first tube body to produce the sealing effect, which minimize the leakage of the fluid.

4. The second flow channel is provided with the movable plug between the push rod and the second tube body; and the movable plug closes the second flow channel. When the first tube body is inserted in the second flow channel and the annular fastener is clamped in the annular clamping groove, the first tube body pushes the movable plug to communicate the first flow channel with the second flow channel. The movable plug has the tube tightly attached to the second tube body. When the first tube body and the second flow channel is disconnected, the movable plug is pushed to fit in the position between the push rod and the second tube body through the fluid pressure in the second flow channel.

What is claimed is:

1. A quick connector, comprising:
a male base, comprising a first tube body, an annular clamping groove arranged outside the first tube body, a first flow channel axially penetrated through the first tube body, a plug body slidably arranged in the first flow channel, and an elastic member pushing the plug body to plug the first flow channel; and
a female base, comprising a second tube body, a second flow channel axially penetrated through the second tube body and provided for the first tube body to be inserted therein, an annular fastener provided in the second flow channel and clamped on the annular clamping groove, and a push rod fixed on the second flow channel and extended towards the plug body, wherein a size of the push rod is matched with a size of the plug body, when the first tube body is inserted into the second flow channel and the annular fastener is fixed to the annular clamping groove, the push rod pushes the elastic member to displace the plug body and to communicate the second flow channel with the first flow channel.

2. The quick connector according to claim 1, wherein the first flow channel comprises a tapered inner surface, and the plug body comprises a tapered outer surface corresponding to the tapered inner surface.

3. The quick connector according to claim 1, wherein the plug body is provided with a first seal ring contacting the first tube body.

4. The quick connector according to claim 1, wherein the annular fastener comprises a plurality of roller balls arranged on the second tube body.

5. The quick connector according to claim 1, wherein the second tube body is provided with a second seal ring adjacent to the push rod contacting the first tube body.

6. The quick connector according to claim 1, wherein one end of the first tube body is provided with a first backstop member, and the other end of the first tube body is inserted into the second flow channel.

7. The quick connector according to claim 1, wherein one end of the second tube body is provided with a second backstop member, and the other end of the second tube body is provided with the annular fastener.

8. The quick connector according to claim 1, wherein the second flow channel is provided with a movable plug which closes the second flow channel between the push rod and the second tube body, and when the annular fastener is clamped in the annular clamping groove, the first tube body pushes the movable plug to communicate the first flow channel with the second flow channel.

9. The quick connector according to claim 8, wherein the push rod and the second tube body are respectively provided with a third seal ring contacting the movable plug.

10. The quick connector according to claim 8, wherein the movable plug comprises a tube tightly attached to the second tube body.
